(19) United States
(12) Patent Application Publication
(10) Pub. No.: US 2014/0285733 A1
(43) Pub. Date: Sep. 25, 2014

(54) TOUCH DISPLAY APPARATUS AND METHOD FOR MANUFACTURING THE SAME

(71) Applicant: Innolux Corporation, Chu-Nan (TW)

(72) Inventors: Meng-Hui CHI, Chu-Nan (TW); Chao-Chun CHUNG, Chu-Nan (TW); Hsi-Chien CHEN, Chu-Nan (TW); Sheng-Shiou YEH, Chu-Nan (TW); Chiu-Lien YANG, Chu-Nan (TW); Jia-Pang PANG, Chu-Nan (TW)

(73) Assignee: Innolux Corporation, Chu-Nan (TW)

(21) Appl. No.: 14/221,810

(22) Filed: Mar. 21, 2014

(30) Foreign Application Priority Data
Mar. 22, 2013 (TW) 102110275

(51) Int. Cl. G06F 3/041; G06F 1/16; G02F 1/1333; G06F 3/044

(52) U.S. Cl. CPC G06F 3/0412; G06F 3/044; G06F 1/169; G02F 1/13338
USPC 349/12; 29/825

(57) ABSTRACT

A touch display apparatus includes a display panel, a first sensing electrode layer and a sensing electrode device. The display panel includes an upper substrate, a lower substrate, and a display medium layer positioned between the upper and lower substrates. The first sensing electrode layer is at one side of the upper substrate opposite to the display medium layer. The sensing electrode device, positioned above the first sensing electrode layer, includes a substrate and a second sensing electrode layer. The second sensing electrode layer is at one side of the substrate. A method for manufacturing the touch display apparatus comprises step of forming the first sensing electrode layer corresponding to one side of the upper substrate. The first and second sensing electrode layers are separately manufactured, and are adhered each other in the subsequent process.

This application claims the benefit of Taiwan application Serial No. 102110275, filed Mar. 22, 2013, the subject matter of which is incorporated herein by reference.

### BACKGROUND OF THE INVENTION

1. Field of the Invention

The invention relates in general to a touch display apparatus and a method for manufacturing the same, and more particularly to a display apparatus with capacitive touch sensor and a method for manufacturing the same.

2. Description of the Related Art

Electronic products, such as smart handsets, portable pads and laptop computers that support display functions, are daily essentials in all aspects including work, learning and personal entertainment fields for modern people. In addition to outstanding electrical characteristics of high quality in display effects, fast response and operation time, long durability and high stability, consumers also seek for richer and more versatile functionalities in the electronic products. Touch panels are extensively applied to the electronic products to facilitate interactions between users and the electronic products. A touch panel is usually disposed at a surface of a display apparatus to allow a user to enter a response by touching an inquiry message displayed on the display apparatus, make a selection by touching an option of a menu displayed on the display apparatus, scroll a menu list, or even provide an entry in a desired format such as drawing an object on the display apparatus or entering texts by handwriting characters.

Apart from the above display effects and operation functions, one of the important features that consumers expect of the electronic products also include whether the electronic products are light in weight, small in size and readily portable.

In a touch display apparatus, current techniques for driving touch display panels are roughly categorized into resistive, optic, capacitive and electromagnetic types. Among the above types, projected capacitive touch panels offer users with good look-and-feel by having a high reliability and supporting multi-touch with a minimal touch force. Therefore, projected capacitive touch panels are widely applied in consumer electronic products such as handsets and portable pads, and are currently a dominant driving technique for touch panels.

According to a location of a touch panel, a touch display apparatus may be categorized as an out-cell, on-cell or in-cell type. In an out-cell touch display apparatus, a touch panel as an additional layer is added to a display panel without a touch function. In an on-cell touch display apparatus, a touch sensor is added, for example, to an upper surface of a color filter (CF) substrate. In an in-cell touch display apparatus, a touch sensor is directly integrated into the structure of a panel. The on-cell and in-cell touch display panels, which do not require an additional touch panel and thus maintain reduced thicknesses in glass and thin films of the panel, adequately satisfy consumer requirements for reduced thickness and weight of electronic products.

### SUMMARY OF THE INVENTION

The invention is directed to a touch display apparatus and a method for manufacturing the touch display apparatus, which integrate a touch function with a display module. Thus, a manufacturing process of the apparatus is simplified for reducing production costs and providing the apparatus with a lighter and slimmer structure. In the embodiments, two sensing electrode layers are separately manufactured in a way that a product yield is significantly increased.

A touch display apparatus is provided by the disclosure. The touch display apparatus at least includes: a display panel, including an upper substrate, a lower substrate, and a display medium layer positioned between the upper substrate and the lower substrate; a first sensing electrode layer, positioned at one side the upper substrate opposite to the display medium layer; and a sensing electrode device, positioned above the first sensing electrode layer, including a substrate and a second sensing electrode layer, wherein the second sensing electrode layer is positioned at one side of the substrate. In one embodiment, for example, the substrate is a flexible substrate, a polarizer, or a substrate made of glass, plastic or another appropriate material.

A method for manufacturing a touch display apparatus is further provided by the disclosure. The method comprises steps of: providing a display panel, which includes an upper substrate, a lower substrate assembled to the upper substrate, and a display medium layer disposed between the upper and lower substrates; disposing a first sensing electrode layer at one side of the upper substrate opposite to the display medium layer; providing a sensing electrode device, which includes a substrate and a second sensing electrode layer formed on the substrate; and disposing the sensing electrode device above the display panel, wherein the first sensing electrode layer is positioned between the upper substrate and the sensing electrode device.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a cross-sectional view of a touch display apparatus according to the first embodiment of the disclosure;

FIG. 2 is a flowchart of a method for manufacturing a touch display apparatus according to the first embodiment of the disclosure;

FIG. 3 is a cross-sectional view of a touch display apparatus according to the second embodiment of the disclosure;

FIG. 4 is a flowchart of a method for manufacturing a touch display apparatus according to the second embodiment of the disclosure;

FIG. 5 is a cross-sectional view of a touch display apparatus according to the third embodiment of the disclosure;

FIG. 6 is a flowchart of a method for manufacturing a touch display apparatus according to the third embodiment of the disclosure;

FIG. 7 is a cross-sectional view of a touch display apparatus according to the fourth embodiment of the disclosure;

FIG. 8 is a flowchart of a method for manufacturing a touch display apparatus according to the fourth embodiment of the disclosure;

FIG. 9 is a cross-sectional view of a touch display apparatus according to the fifth embodiment of the disclosure; and

FIG. 10 is a flowchart of a method for manufacturing a touch display apparatus according to the fifth embodiment of the disclosure.

### DETAILED DESCRIPTION OF THE INVENTION

A touch display apparatus and a method for manufacturing the touch display apparatus are provided by embodiments of the disclosure. In the disclosed embodiments, a touch function is integrated with a display module. Compared to a conventional out-cell touch panel, the touch display apparatus of the embodiments is capable of reducing one or even two layers of films for disposing a sensing electrode layer, so as to reduce material costs and provide a slimmer and lighter apparatus. Further, the method for manufacturing the touch display panel disclosed by the embodiments not only simplifies a manufacturing process and lowers the production costs, but also significantly increases the product yield.

Each of the disclosed embodiments has one or more technical features. However, it does not mean that implementation of the application needs every technical feature of any embodiment of the application or combination of the embodiments of the application is prohibited. In other words, in possible implementation, one skilled person in the art would selectively implement part or all technical features of any embodiment of the application or selectively combine part or all technical features of the embodiments of the application based on the disclosure of the application and his/her own need. Further, shapes, sizes and ratios of the objects are exemplary for one skilled person in the art to understand the application, not to limit the application.

### First Embodiment

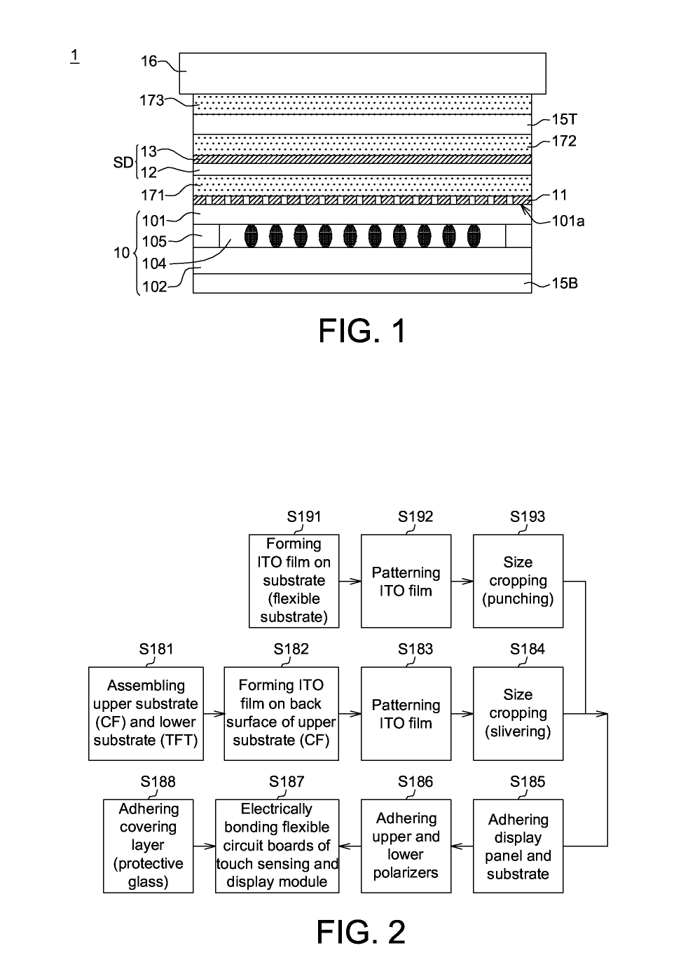

FIG. 1 is a cross-sectional view of a touch display apparatus according to the first embodiment of the present invention. Referring to FIG. 1, a touch display apparatus 1 at least includes a display panel 10, a first sensing electrode layer 11, and a sensing electrode device SD. The display panel 10 includes an upper substrate 101, a lower substrate 102, and a display medium layer 104 disposed between the upper substrate 101 and the lower substrate 102. The sensing electrode device SD, positioned above the first sensing electrode layer 11, includes a substrate 12 and a second sensing electrode layer 13. The second sensing electrode layer 13 is at one side of the substrate 12. In one embodiment, for example, the upper substrate 101 and the lower substrate 102 are a color filter (CF) substrate and a thin-film transistor (TFT) array substrate, respectively. Further, for example, the display medium layer 104 is a liquid crystal (LC) layer, and is applied with a sealant 105 around a substrate display region. As such, bonding stress is generated as the sealant 105 is cured (hardened) for assembling the TFT array substrate and the CF substrate, and to form a closed space for enclosing liquid crystals therein.

The first sensing electrode layer 11 is positioned on one side of the upper substrate 101 opposite to the display medium layer 104. In the first embodiment, the first sensing electrode layer 11 is directly formed on a back surface 101a of the upper substrate 11.

In the first embodiment, for example, the substrate 12 is a flexible substrate made of polyethylene terephthalate (PET) or another suitable material, and the second sensing electrode layer 13 is directly formed on the substrate 12.

As shown in FIG. 1, the touch display apparatus 1 further includes an upper polarizer 15T, a lower polarizer 15B, a covering layer 16, a first optical clear adhesive (OCA) 171, a second OCA 172, and a third OCA 173. The upper polarizer 15T is positioned between the covering layer 16 and the sensing electrode device SD (e.g., the substrate 12), and the lower polarizer 15B is positioned at a surface of the lower substrate 102. The covering layer 16 is positioned above the sensing electrode device SD (e.g., the second sensing electrode layer 13), and is made of transparent protective glass, plastic or another appropriate transparent protective material, for example. The first OCA 171 is disposed between the first sensing electrode layer 11 and the sensing electrode device (e.g., the substrate 12); the second OCA 172 is disposed between the upper polarizer 15T and the sensing electrode device (e.g., the second sensing electrode layer 13); the third OCA 173 is disposed between the upper polarizer 15T and the covering layer 16. The upper polarizer 15T and the lower polarizer 15B may be selectively subjected to the polarizing treatment according to the requirements of applications.

In one embodiment, for example, the second sensing electrode layer 13 may be disposed between the substrate 12 and the upper polarizer 15T, as shown in FIG. 1, or be disposed between the substrate 12 and the first sensing electrode layer 11. A coated surface of the second sensing electrode layer 13 may face upwards or downwards, depending on the requirements of product design and not limited herein.

In one embodiment, for example, the first sensing electrode layer 11 and the second sensing electrode layer 13 are a driving electrode Tx and a sensing electrode Rx respectively, which can be formed by an ITO film forming process and related patterning process such as photolithography. Taking a projected capacitive touch panel for example, the electrode structures of the first sensing electrode layer 11 and the second sensing electrode layer 13 are arranged along x-axis and y-axis directions, respectively, as x-axis electrodes and y-axis electrodes that are perpendicular to each other. In one embodiment, a multi-touch loop is generated by forming the first sensing electrode layer 11 (Tx) on the back surface 101a of the CF substrate (the upper substrate 101) and the second sensing electrode layer 13 (Rx) on the substrate 12 (a flexible substrate).

Further, in the embodiment, the touch control function is integrated with a display module, and light beams sequentially pass through the lower polarizer 15B, the substrate 12 (the flexible substrate) and the upper polarizer 15T. To prevent effects on an overall optical phase differences of the touch display apparatus 1, the substrate 12 can be made from an isotropic material, i.e., a material that has a same refractive index for directions of main axes (nₓ=n_{y}=n_{z}), such as cyclo olefin (COP) or other appropriate materials.

FIG. 2 shows a flowchart of a method for manufacturing the touch display apparatus according to the first embodiment of the disclosure. Details are given below with reference to FIG. 1 and FIG. 2.

In step S181, an upper substrate 101 (e.g., a CF substrate), a lower substrate 102 (e.g., a TFT array substrate), and a display medium layer 104 (e.g., an LC layer) positioned between the upper substrate 101 and the lower substrate 102 are assembled and provided. A first sensing electrode layer 11 is formed at a back surface 101a of the upper substrate 11. More specifically, an ITO film is formed at the back surface of the upper substrate 101 in step S182, and the first sensing electrode layer 11 is formed by patterning the ITO film in step S183. In step S184, a sliver process is performed to crop the assembled upper substrate 101, lower substrate 102 and first sensing electrode layer 11 to form the display panel 10 and the first sensing electrode layer 11 in a predetermined size shown in FIG. 1.

Further, a substrate 12, e.g., a flexible substrate, is provided, and a second sensing electrode layer 13 is formed on the substrate 12 to form a sensing electrode device SD. More specifically, an ITO film is formed at a surface of the substrate 12 in step S191, and the second sensing electrode layer 13 is formed by patterning the ITO film in step S192. In step S184, a cropping process is performed. For example, the flexible substrate and the second sensing electrode layer 13 are punched and thus cropped into a predetermined size corresponding to the display panel 10.

In step S185, the first sensing electrode 11 and the substrate 12 (ex: a flexible substrate) of the display panel 10 are adhered by using a first OCA 171. In step S186, an upper polarizer 15T and a lower polarizer 15B are adhered. More specifically, the upper polarizer 15T is adhered above the substrate 12 (e.g., adhering the upper polarizer 15T and the second sensing electrode layer 13 by using the second OCA 172 as shown in FIG. 1), and the lower polarizer 15B is adhered to a surface of the lower substrate 102.

In step S187, a bonding procedure is performed on a touch sensing flexible circuit board and a flexible circuit board of the display module. In step S188, a covering layer 16 (e.g., a protective glass CG) is adhered to the upper polarizer 15T by using a third OCA 173.

As such, the method for manufacturing a touch display apparatus disclosed in the first embodiment is conducted by adopting two film processes (e.g., Tx+Rx), two lithography processes and three adhesion processes (e.g., the adhesion of the display panel 10 and the substrate 12, the adhesion of the polarizers 15T/15B, and the adhesion of the covering layer 16), which provides a simple structure and simplifies the manufacturing process.

As disclosed in the above embodiments, the touch display apparatus and the method for manufacturing the touch display apparatus integrating a touch function with a display module. That is, the first sensing electrode layer 11 is formed at the back surface (e.g., at one side of the upper substrate opposite to the display medium layer) of the upper substrate of the display panel, the second sensing electrode layer 13 is separately manufactured, and the structures of the two sensing electrode layers are adhered to each other. Such method reduces film materials utilized for sensing electrode layers, and is thus capable of decreasing the thickness of the apparatus as well as simplifying an overall manufacturing process. Further, in the embodiments, the first sensing electrode layer 11 and the second sensing electrode layer 13 are separately manufactured and later adhered to each other; therefore, the processing time and complexity of the manufacturing method are reduced, so as to significantly increase the product yield and decrease the production cost.

### Second Embodiment

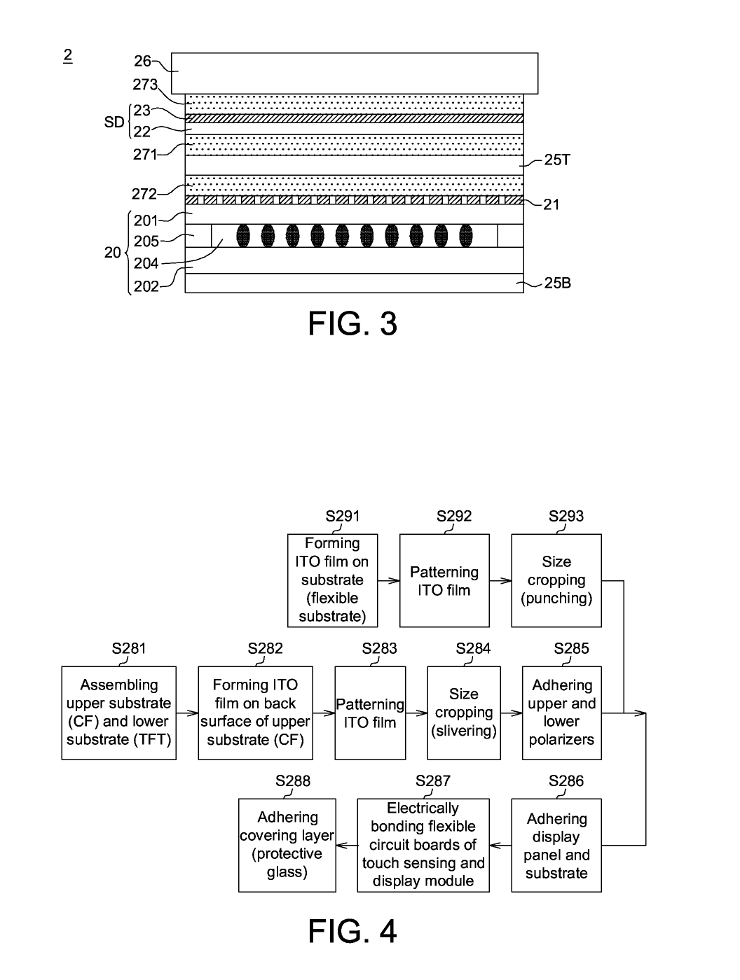

FIG. 3 is a cross-sectional view of a touch display apparatus according to the second embodiment of the disclosure. Compared to the first embodiment, a position of the upper polarizer 15T is changed in the touch display apparatus according to the second embodiment. In the second embodiment, the remaining elements have structures similar to those in the first embodiment and thus have the same denotations.

In the second embodiment, a touch display apparatus 2 at least includes a display panel 20 (an upper substrate 201, a lower substrate 202 and a display medium layer 204), a first sensing electrode layer 21 positioned on a back surface 201a of the upper substrate 201, and a sensing electrode device SD (including a substrate 22 (a flexible substrate) and a second sensing electrode layer 23). The touch display apparatus 2 further includes an upper polarizer 25T, lower polarizer 25B, a covering layer 26, a first OCA 271, a second OCA 272 and a third OCA 273. The upper polarizer 25T is disposed on the first sensing electrode layer 21, and is positioned between the first sensing electrode layer 21 and the substrate 22. The lower polarizer 25B is positioned at a surface of the lower substrate 202. The first OCA 271 is positioned between the substrate 22 and the upper polarizer 25T. The covering layer 26, e.g., protective glass, is positioned above the second sensing electrode layer 23. The second OCA 272 is positioned between the sensing electrode device SD (e.g., the upper polarizer 25T) and the first sensing electrode layer 21. The third OCA 273 is positioned between the sensing electrode device SD (e.g., the second sensing electrode layer 23) and the covering layer 26.

Similarly, unlimited by the disclosure, a coated surface of the second sensing electrode layer 13 may face upwards or downwards according to design requirements. In the second embodiment, the second sensing electrode layer 23 may be positioned between the substrate 22 and the third OCA 273 as depicted in FIG. 2, or positioned between the substrate 22 and the first OCA 271.

When implementing the second embodiment, the upper polarizer 25T is disposed at one side of the upper substrate 201 (e.g., a CF substrate), such that light beams first pass through the lower polarizer 25B and the upper polarizer 25T and then the substrate 22, thereby preventing retardation generated by the substrate and thus further mitigating risks of light leakage and reduced contrast of a display module (e.g., an LCD).

FIG. 4 shows a flowchart of a method for manufacturing a touch display apparatus according to the second embodiment of the disclosure. Details are given with reference to FIG. 3 and FIG. 4 below.

In step S281, an upper substrate 201 (e.g., a CF substrate), a lower substrate 202 (e.g., a TFT array substrate), and a display medium layer 204 (e.g., an LC layer) positioned between the upper substrate 201 and the lower substrate 202 are assembled and provided. A first sensing electrode layer 21 is formed at a back surface 201a of the upper substrate 21. More specifically, an ITO film is formed at the back surface of the upper substrate 201 in step S282, and the first sensing electrode layer 21 is formed by patterning the ITO film in step S283.

In step S284, a sliver process is performed to crop the assembled upper substrate 201, lower substrate 202 and first sensing electrode layer 21 to form the display panel 20 and the first sensing electrode layer 21 in a predetermined size shown in FIG. 3. In step S285, an upper polarizer 25T and a lower polarizer 25B are adhered.

Further, a sensing electrode device SD is formed, including steps of providing a substrate 22 such as a flexible substrate and forming a second sensing electrode layer 23 on the substrate 22. More specifically, an ITO film is formed at a surface of the substrate 22 in step S291, and the ITO film is patterned to form the second sensing electrode layer 23 in step S292. In step S293, a cropping process is performed. For example, the substrate 22 and the second sensing electrode layer 23 are punched and thus cropped into a predetermined size corresponding to the display panel 20.

In step S286, the substrate 22 and the upper polarizer 25T are adhered by using a first OCA 271, and the upper polarizer 25T and the first sensing electrode layer 21 are adhered by using a second OCA 272. In step S287, a bonding process is performed on a touch sensing flexible circuit board and a flexible circuit board of the display module. In step S288, a covering layer 26 (e.g., protective glass CG) and the sensing electrode device SD (e.g., the second sensing electrode layer 23) are adhered by using a third OCA 273.

As such, the method for manufacturing a touch display apparatus disclosed in the second embodiment is conducted by adopting two film processes (e.g., Tx+Rx), two lithography processes and three adhesion processes (e.g., the adhesion of the display panel 20 and the substrate 22, the adhesion of the polarizers 25T/25B, and the adhesion of the covering layer 26), which provides a simple structure and simplifies the manufacturing process.

### Third Embodiment

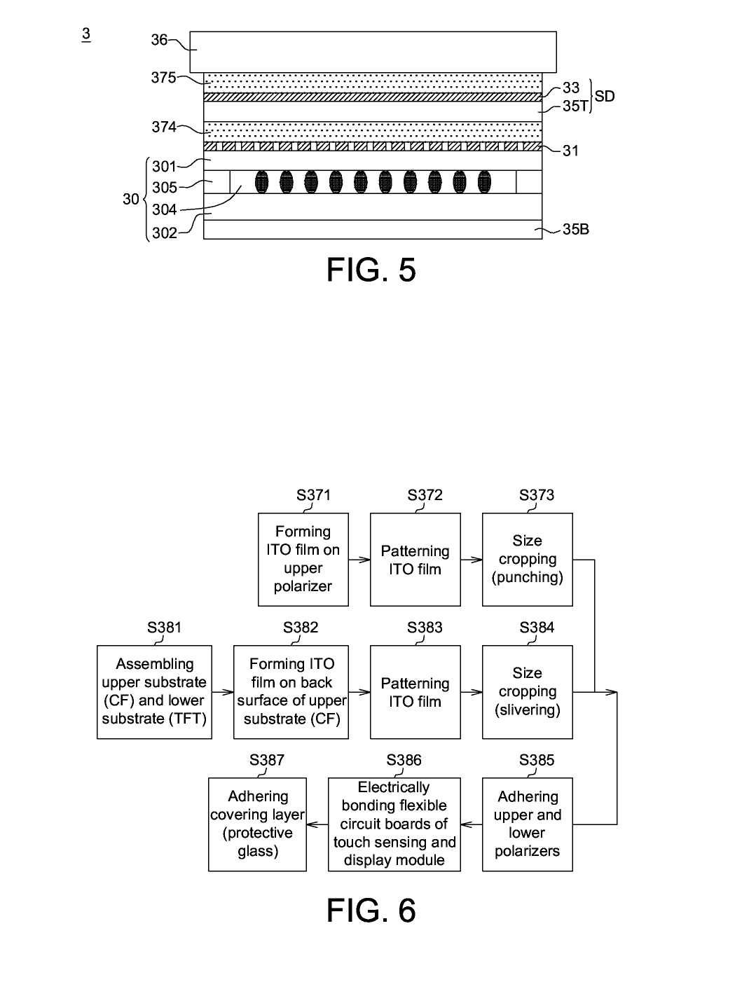

FIG. 5 is a cross-sectional view of a touch display apparatus according to the third embodiment of the disclosure. In the third embodiment, the elements the same as or similar to those in the first embodiment are represented in the same or similar denotations.

In the third embodiment, a touch display apparatus 3 at least includes a display panel 30 (including an upper substrate 301, a lower substrate 302 and a display medium layer 304), a first sensing electrode layer 31 disposed at one side of the upper substrate 301 opposite to the display medium layer 304 (e.g., directly formed on a back surface 301a of the upper substrate 301), and a sensing electrode device SD (including a substrate and a second sensing electrode layer 33).

In the embodiment, an upper polarizer 35T serves as a substrate, onto which the second sensing electrode layer 33 is formed to form the sensing electrode device SD. Further, the upper polarizer 35T, disposed above the first sensing electrode layer 31 (by an OCA 375), is selected from an appropriate material having good thermal stability, so that the upper polarizer 35T is capable of bearing a coating temperature and does not deteriorate during the patterning process. In one embodiment, the coating process of the sensing electrode layer may be conducted in a low temperature, e.g., at approximately 150° C.

The touch display apparatus 3 further includes a lower polarizer 35B at a surface of the lower substrate 302, a covering layer 36 (e.g., protective glass) positioned above the second sensing electrode layer 33, an OCA 374 disposed between the upper polarizer 35T and the first sensing electrode layer 31, and an OCA 375 disposed between the sensing electrode device (e.g., the upper polarizer 35T) and the covering layer 36.

Similarly, unlimited by the disclosure, a coated surface of the second sensing electrode layer 33 may face upwards or downwards according to design requirements. In the third embodiment, the second sensing electrode layer 33 may be disposed between the upper polarizer 35T and the OCA 375 as shown in FIG. 5, or disposed between the upper polarizer 35T and the first sensing electrode layer 31 while being also insulated by another OCA.

FIG. 6 shows a flowchart of a method for manufacturing a touch display apparatus according to the third embodiment of the disclosure. Details are given below with reference to FIG. 5 and FIG. 6.

In step S381, an upper substrate 301 (e.g., a CF substrate), a lower substrate 302 (e.g., a TFT array substrate), and a display medium layer 304 positioned between the upper substrate 301 and the lower substrate 302 are assembled and provided. A first sensing electrode layer 31 is formed at a back surface 301a of the upper substrate 301. More specifically, an ITO film is formed at the back surface of the upper substrate 301 in step S382, and the first sensing electrode layer 31 is formed by patterning the ITO film in step S383.

In step S384, a sliver process is performed to crop the assembled upper substrate 301, lower substrate 302 and first sensing electrode layer 31 to form a display panel 30 and the first sensing electrode layer 21 in a predetermined size shown in FIG. 5.

Further, a second sensing electrode layer 33 is formed on a polarizer to form a sensing electrode device SD. More specifically, an ITO film is formed on a polarizer (to be later utilized as an upper polarizer 35T) in step S371, and the sensing electrode layer 33 is formed by patterning the ITO film in step S372. The polarizer is made of an appropriate material having good thermal stability, so that the polarizer is capable of bearing a coating temperature and does not deteriorate during the patterning process. In one embodiment, the coating process of the polarizer may be conducted in a low temperature, e.g., at approximately 150° C.

In step S373, a cropping process is performed. For example, the upper polarizer 35T and the second sensing electrode layer 33 are punched and thus slivered into a predetermined size corresponding to the display panel 30 in FIG. 5.

In step S385, the upper polarizer 35T and a lower polarizer 35B are adhered. For example, the upper polarizer 35T and the first sensing electrode layer 31 are adhered by using an OCA 374, and the second sensing electrode layer 33 of the upper polarizer 35T is disposed facing a touch control plane, for example.

In step S386, a bonding process is performed on a touch sensing flexible circuit board and a flexible circuit board of the display module. In step S387, a covering layer 36 and the upper polarizer 35T are adhered by using an OCA 375.

As such, the method for manufacturing a touch display apparatus disclosed in the third embodiment is conducted by adopting two film processes (e.g., Tx+Rx), two lithography processes and two adhesion processes (e.g., the adhesion of the polarizers 35T/35B, and the adhesion of the covering layer 36), which provides a simple structure and simplifies the manufacturing process. Further, the touch display apparatus of the third embodiment eliminates a film material conventionally required for disposing a sensing electrode layer, and thus simplifies an overall adhesion process while also reducing material costs and providing a slimmer and lighter apparatus.

### Fourth Embodiment

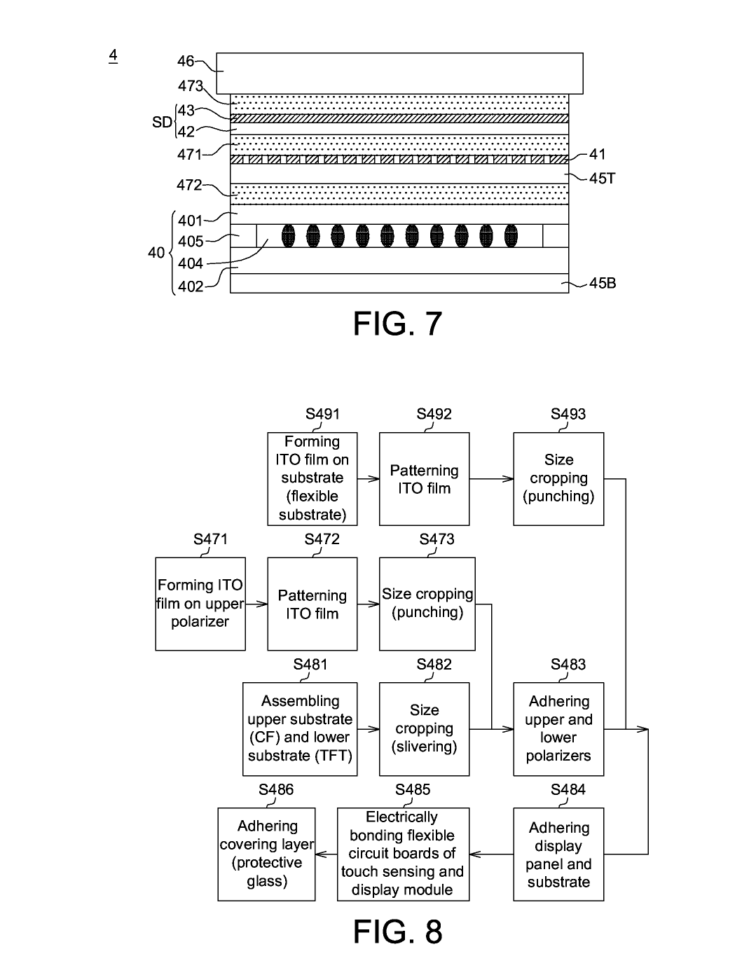

FIG. 7 is a cross-sectional view of a touch display apparatus according to the fourth embodiment of the disclosure. Compared to the touch display apparatus 1 of the first embodiment, in a touch display apparatus 4 of the fourth embodiment, a first sensing electrode layer 41 at a back surface of an upper substrate 401 is directly formed on an upper polarizer 45T. The remaining elements in the fourth embodiment have structures similar to those in the first embodiment, and thus have the same denotations.

In the fourth embodiment, the touch display apparatus 4 at least includes a display panel 40 (including an upper substrate 401, a lower substrate 402 and a display medium layer 404), a first sensing electrode layer 41, a substrate 42 (a flexible substrate) and a sensing electrode device SD (including the substrate 42 and a second sensing electrode layer 43). An upper polarizer 45T is positioned at a back surface of the upper substrate 401, and is positioned at one side of the upper substrate 401 opposite to the first sensing electrode layer 41 to be directly formed on the upper polarizer 45T. The touch display apparatus 4 further includes a lower polarizer 45B positioned at a surface of the lower substrate 402, a first OCA 471 between the substrate 42 and the first sensing electrode layer 41, a covering layer 46 (e.g., protective glass) positioned above the second sensing electrode layer 43, a second OCA 472 disposed between the upper polarizer 45T and the upper substrate 401, and a third OCA disposed between the sensing electrode device SD and the covering layer 46.

Similarly, unlimited by the disclosure, a coated surface of the second sensing electrode layer 43 may face upwards or downwards according to design requirements. In the fourth embodiment, the second sensing electrode layer 43 may be disposed between the substrate 42 and the third OCA 473 as in FIG. 7, or disposed between the substrate 42 and the first OCA 471.

When implementing the fourth embodiment, the upper polarizer 45T is disposed at one side of the upper substrate 401 (e.g., a CF substrate), such that light beams firstly pass through the lower polarizer 45B and the upper polarizer 45T and then the substrate 42 (ex: a flexible substrate), thereby preventing retardation generated by the substrate 42 and thus further mitigating risks of light leakage and reduced contrast of a display module (e.g., an LCD).

FIG. 8 shows a flowchart of a method for manufacturing a touch display apparatus according to the fourth embodiment of the disclosure. Details are given with reference to FIG. 7 and FIG. 8 below.

A first sensing electrode layer 41 is formed on a polarizer. More specifically, an ITO film is formed on a polarizer (to be later utilized as an upper polarizer 45T) in step S471, and the first sensing electrode layer 41 is formed by patterning the ITO film in step S472. The polarizer is made from an appropriate material having good thermal stability, so that the polarizer is capable of bearing a coating temperature and does not deteriorate from the patterning process. In one embodiment, the coating process of the polarizer may be conducted in a low temperature, e.g., at approximately 150° C.

In step S473, a cropping process is performed. For example, the upper polarizer 45T and the first sensing electrode layer 41 are punched and thus slivered into a predetermined size corresponding to the display panel 40 in FIG. 7.

In step S481, an upper substrate 401 (e.g., a CF substrate), a lower substrate 402 (e.g., a TFT array substrate), and a display medium layer 404 positioned between the upper substrate 401 and the lower substrate 402 are assembled and provided. In step S482, a sliver process is performed to crop the assembled upper substrate 401, lower substrate 402 and first sensing electrode layer 41 to form the display panel 40 and the first sensing electrode layer 41 in a predetermined size shown in FIG. 7.

In step S483, the upper polarizer 45T and a lower polarizer 45B are adhered to the display panel 40. The upper polarizer 45T and the upper substrate 401 are adhered using a second OCA 472, and the first sensing electrode layer 41 at the upper polarizer 45T is disposed facing a touch control plane.

Further, a substrate 42, e.g., a flexible substrate, is provided, and a second sensing electrode layer 43 is formed on the substrate 42 to form a sensing electrode device SD. More specifically, an ITO film is formed at a surface of the substrate 42 in step S491, and the second sensing electrode layer 43 is formed by patterning the ITO film in step S492. In step S493, a cropping process is performed. For example, the substrate 42 and the second sensing electrode layer 43 are punched and slivered into a predetermined size corresponding to the display panel 40.

In step S484, the sensing electrode device SD and the display panel 40 including the upper polarizer 45T are adhered by using a first OCA 471. The first sensing electrode layer 41 is disposed between the upper polarizer 45T and the first OCA 471.

In step S485, a bonding process is performed on a touch sensing flexible circuit board and a flexible circuit board of the display module. In step S486, a covering layer 46 (e.g., protective glass) and the substrate 42 are adhered by using a third OCA 473.

As such, the method for manufacturing a touch display apparatus disclosed in the fourth embodiment is conducted by adopting two film processes (e.g., Tx+Rx), two lithography processes and three adhesion processes (e.g., the adhesion of the polarizers 45B/45T, the adhesion of the display panel 40 and the substrate 42, and the adhesion of the covering layer 46), which provides a simple structure and simplifies the manufacturing process.

### Fifth Embodiment

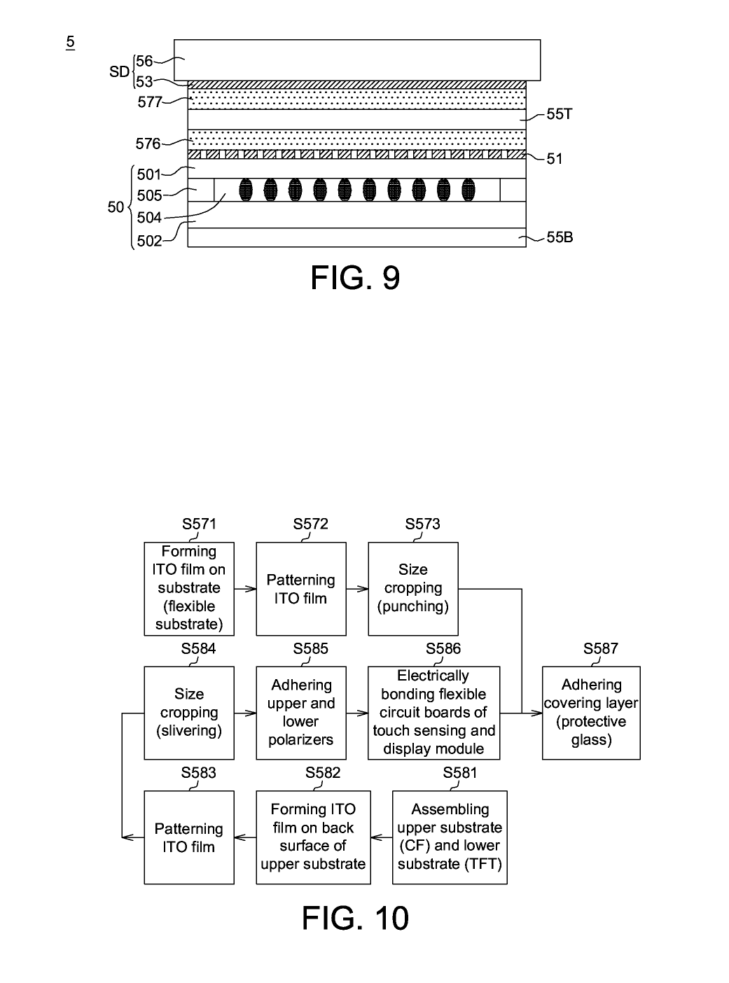

FIG. 9 is a cross-sectional view of a touch display apparatus according to the fifth embodiment of the disclosure. In the fifth embodiment, the elements the same as or similar to those in the first embodiment are represented in the same or similar denotations.

In the fifth embodiment, a touch display apparatus 5 at least includes a display panel 50 (including an upper substrate 501, a lower substrate 502 and a display medium layer 504), a first sensing electrode layer 51 disposed at one side of the upper substrate 501 opposite to the display medium layer 504, and a sensing electrode device SD (including a substrate (also serving as a covering layer 56) and a second sensing electrode layer 53).

In the embodiment, for example, the covering layer 56 is a glass substrate, on which a second sensing electrode layer 53 is formed to form the sensing electrode device SD. Besides the transparent glass, the covering layer 56 of the touch display apparatus 5 may also be made of a transparent plastic substrate or other appropriate material.

In the fifth embodiment, the touch display apparatus 5 further includes an upper polarizer 55T disposed between the first sensing electrode layer 51 and the second sensing electrode layer 53, a lower polarizer 55B positioned at a surface of the lower substrate 502, and two OCAs 576 and 577. As shown in FIG. 9, the second sensing electrode layer 53 formed on the glass substrate faces the first sensing electrode layer 51, the OCA 576 is disposed between the upper polarizer 55T and the first sensing electrode layer 51, and the OCA 577 is disposed between the upper polarizer 55T and the second sensing electrode layer 53.

FIG. 10 shows a flowchart of a method for manufacturing a touch display apparatus according to the fifth embodiment of the disclosure. Details are given below with reference to FIG. 9 and FIG. 10.

In step S581, an upper substrate 501 (e.g., a CF substrate), a lower substrate 502 (e.g., a TFT array substrate), and a display medium layer 504 (e.g., an LC layer) positioned between the upper substrate 501 and the lower substrate 502 are assembled and provided. A first sensing electrode layer 51 is formed at a back surface 501a of the upper substrate 51. More specifically, an ITO film is formed at a back surface of the upper substrate 501 in step S582, and the first sensing electrode layer 51 is formed by patterning the ITO film in step S583.

In step S584, a sliver process is performed to crop the assembled upper substrate 501, lower substrate 502 and first sensing electrode layer 51 to form a display panel 50 and the first sensing electrode layer 51 in a predetermined size shown FIG. 9.

In step S585, the upper polarizer 55T and a lower polarizer 55B are adhered, and the upper polarizer 55T and the first sensing electrode layer 51 are adhered by using an OCA 576. In step S586, a bonding process (electrical bonding) is performed on a touch sensing flexible circuit board and a flexible circuit board of the display module.

Further, a second sensing electrode layer 53 is formed on a substrate (e.g., a glass or plastic substrate, or a substrate of another appropriate material) to form a sensing electrode element SD. For example, an ITO film is formed on a glass substrate in step S571, and a second sensing electrode layer 53 is formed by patterning the ITO film in step S572.

In step S573, a cropping process is performed. For example, the substrate and the second sensing electrode layer 53 are punched and slivered into a predetermined size corresponding to the display panel 50 in FIG. 9. The slivered substrate serves as the covering layer 56 of the touch display apparatus 5.

In step S587, a covering layer 56 and the upper polarizer 55T are adhered by using an OCA 577. The second sensing electrode layer 53 is formed on the glass substrate and disposed facing the OCA 577, and is positioned between the upper polarizer 55T and the glass substrate (the covering layer 56).

As such, the method for manufacturing a touch display apparatus disclosed in the fifth embodiment is conducted by adopting two film processes (e.g., Tx+Rx), two lithography processes and two adhesion processes (e.g., the adhesion of the polarizers 55T/55B, and the adhesion of the covering layer 56), which provides a simple structure and simplifies the manufacturing process. Further, since the two sensing electrodes (e.g., Tx and Rx) of the touch display apparatus of the fifth embodiment are insulated from the upper polarizer 55T through the OCAs 576 and 577, a film material conventionally required for disposing a sensing electrode layer is eliminated. Therefore, the above structure simplifies an overall adhesion process while also reducing material costs and providing a slimmer and lighter apparatus.

In the touch display apparatus and the method for manufacturing the touch display panel according to the above embodiments, a touch function is integrated with a display module, and the first sensing electrode layer (11/21/31/41/51) is formed on the side of upper substrate of the display panel (the side opposite to a display medium layer). Therefore, the thickness of the apparatus is reduced to offer a lighter and slimmer apparatus with a simpler manufacturing process. In the embodiments, a structure for disposing one or two films of the sensing electrode layer can be eliminated. Further, in the embodiments, the first sensing electrode layer (11/21/31/41/51) and the second sensing electrode layer (13/23/33/43/53) are separately (individually) manufactured. For example, at one side of the upper substrate (e.g., a CF substrate), the first sensing electrode layer is directly formed at the back surface of the CF substrate or directly formed on the upper polarizer, and the second sensing electrode layer is formed on a flexible substrate, a polarizer or a glass substrate. In the subsequent manufacturing process, the two sensing electrode layers are adhered to each other. The above method facilitates the manufacturing of the sensing electrode layers, so that the yield of the structures of the sensing electrode layers are increased while also minimizing risks of contaminations or damages on the elements of the display module during the manufacturing process of the sensing electrodes. Accordingly, the touch display apparatus and the method for manufacturing the touch display apparatus according to the embodiments provide a lighter and slimmer structure by using a simpler manufacturing process, thereby reducing manufacturing time and production cost, and significantly increasing a product yield.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display apparatus, comprising:
a display panel, comprising an upper substrate, a lower substrate and a display medium layer positioned between the upper substrate and the lower substrate;
a first sensing electrode layer, positioned at one side of the upper substrate opposite to the display medium layer; and
a sensing electrode device, positioned above the first sensing electrode layer, comprising a substrate and a second sensing electrode layer, wherein the second sensing electrode layer is at one side of the substrate.

2. The touch display apparatus according to claim 1, further comprising a covering layer positioned above the sensing electrode device.

3. The touch display apparatus according to claim 2, further comprising an upper polarizer disposed between the covering layer and the sensing electrode device.

4. The touch display apparatus according to claim 3, wherein the second sensing electrode layer is positioned between the substrate and the upper polarizer, or between the substrate and the first sensing electrode layer.

5. The touch display apparatus according to claim 4, further comprising:
a first optical clear adhesive (OCA), positioned between the first sensing electrode layer and the sensing electrode device;
a second OCA, positioned between the upper polarizer and the sensing electrode device; and
a third OCA, positioned between the upper polarizer and the covering layer.

6. The touch display apparatus according to claim 2, further comprising:
an upper polarizer, positioned between the first sensing electrode layer and the sensing electrode device.

7. The touch display apparatus according to claim 6, wherein the second sensing electrode layer is disposed between the substrate and the covering layer, or between the substrate and the upper polarizer.

8. The touch display apparatus according to claim 7, further comprising:
a first OCA, positioned between the first sensing electrode layer and the upper polarizer;
a second OCA, positioned between the sensing electrode device and the first sensing electrode layer; and
a third OCA, positioned between the upper polarizer and the covering layer.

9. The touch display apparatus according to claim 2, further comprising:
an upper polarizer, positioned at the one side of the substrate opposite to the display medium layer, wherein the first sensing electrode layer is formed on the upper polarizer.

10. The touch display apparatus according to claim 9, wherein the second sensing electrode layer is positioned between the substrate and the covering layer, or between the substrate and the first sensing electrode layer.

11. The touch display apparatus according to claim 10, further comprising:
a first OCA, positioned between the sensing electrode device and the first sensing electrode layer;
a second OCA, positioned between the upper polarizer and the upper substrate; and
a third OCA, positioned between the sensing electrode device and the covering layer.

12. The touch display apparatus according to claim 1, wherein the substrate is an upper polarizer, the second sensing electrode layer is formed on the upper polarizer, and the first sensing electrode layer is formed at the one side of the upper substrate opposite to the display medium layer.

13. The touch display apparatus according to claim 12, further comprising:
a covering layer, positioned above the sensing electrode device; and
two OCAs, positioned between the sensing electrode device and the covering layer, and between the upper polarizer and the first sensing electrode layer, respectively.

14. The touch display apparatus according to claim 13, wherein the second sensing electrode is positioned between the upper polarizer and one of the OCAs, or between the upper polarizer and the first sensing electrode layer and insulated by another one of the OCAs.

15. The touch display apparatus according to claim 1, wherein the substrate is a covering layer, the second sensing electrode layer is formed on the substrate and disposed facing the first sensing electrode layer, and the first sensing electrode layer is formed at the one side of the upper substrate opposite to the display medium layer.

16. The touch display apparatus according to claim 15, further comprising:
an upper polarizer, positioned between the first sensing electrode layer and the second sensing electrode layer; and
two OCAs, positioned between the upper polarizer and the second sensing electrode layer, and between the upper polarizer and the first sensing electrode layer, respectively.

17. The touch display apparatus according to claim 1, wherein the upper substrate and the lower substrate are a color filter (CF) substrate and a thin-film transistor (TFT) array substrate respectively, and the display medium layer is a liquid-crystal (LC) layer.

18. A method for manufacturing a touch display apparatus, comprising:
providing a display panel, the display panel comprising an upper substrate, a lower substrate assembled to the upper substrate, and a display medium layer disposed between the upper substrate and the lower substrate;
disposing a first sensing electrode layer at one side of the upper substrate opposite to the display medium layer;
providing a sensing electrode device, the sensing electrode device comprising a substrate and a second sensing electrode layer formed on the substrate; and
disposing the sensing electrode device above the display panel, wherein the first sensing electrode layer is positioned between the upper substrate and the sensing electrode device.

19. The method according to claim 18, further comprising:
disposing a covering layer above the sensing electrode device.

20. The method according to claim 19, wherein the step of disposing the first sensing electrode layer at the upper substrate comprises:
forming the first sensing electrode layer at the one side of the upper substrate opposite to the display medium layer.

21. The method according to claim 20, further comprising:
adhering the sensing electrode device and the first sensing electrode layer by using a first OCA;
adhering an upper polarizer onto the sensing electrode device by using a second OCA, and disposing a lower polarizer to a surface of the lower substrate; and
adhering the upper polarizer and the covering layer by using a third OCA.

22. The method according to claim 20, comprising:
disposing an upper polarizer on the first sensing electrode layer, and disposing a lower polarizer to a surface of the lower substrate;
adhering the sensing electrode device and the upper polarizer by using a first OCA;
adhering the upper polarizer and the first sensing electrode layer by using a second OCA; and
adhering the sensing electrode device and the covering layer by using a third OCA.

23. The method according to claim 19, wherein the step of disposing the first sensing electrode layer at the upper substrate further comprises:
providing an upper polarizer and forming the first sensing electrode layer on the upper polarizer; and
disposing the upper polarizer having the first sensing electrode layer to the one side of the upper substrate opposite to the display medium layer, and disposing a lower polarizer to a surface of the lower substrate.

24. The method according to claim 23, further comprising:
adhering the sensing electrode device and the upper polarizer by using a first OCA;
adhering the upper polarizer and the upper substrate by using a second OCA; and
adhering the sensing electrode device and the covering layer by using a third OCA.

25. The method according to claim 18, wherein the substrate is an upper polarizer, and the second sensing electrode layer is formed on the upper polarizer.

26. The method according to claim 25, comprising:
adhering a covering layer and the sensing electrode device by using an OCA, wherein the covering layer is positioned above the sensing electrode device.

27. The method according to claim 18, wherein the substrate is a covering layer, and the second sensing electrode layer is formed at one side of the covering layer.

28. The method according to claim 27, comprising:
forming the first sensing electrode layer at the one side of the upper substrate opposite to the display medium layer;
disposing the upper polarizer above the first sensing electrode layer, and disposing a lower polarizer to a surface of the lower substrate; and
adhering the sensing electrode device and the upper polarizer by using an OCA, wherein the second electrode sensing layer is disposed facing the OCA and is positioned between the upper polarizer and the covering layer.
